(19) United States
(12) Patent Application Publication
(10) Pub. No.: US 2009/0128621 A1
(43) Pub. Date: May 21, 2009

(54) System and/or method for automated stereoscopic alignment of images

(76) Inventors: Charles Gregory Passmore, San Diego, CA (US); Brian Lanehart, Norcross, GA (US)

Correspondence Address: PATENTS+TMS, P.C., 2849 W. ARMITAGE AVE., CHICAGO, IL, 60647, US

(21) Appl. No.: 11/986,490

(22) Filed: Nov. 21, 2007

(51) Int. Cl. H04N 13/00

(52) U.S. Cl. 348/43; 348/E13.001

(57) ABSTRACT

A system and/or a method provide automated stereoscopic alignment of images. The system and/or the method provide automated stereoscopic alignment of images, such as, for example, two or more video streams. A camera array and/or a target capture and/or scale the images. A computer is programmed to automatically align the images in a post production process after the images are captured by the camera array. The computer may, alternatively, be programmed to automatically align cameras with motors in the camera array, simultaneously, while filming the images.

### BACKGROUND OF THE INVENTION

The present invention generally relates to a system and/or a method for automated stereoscopic alignment of images. More specifically, the present invention generally relates to a system and/or a method for automated stereoscopic alignment of images, such as, for example, two or more video streams. The system and/or the method may have a camera array and/or a target to capture and/or to scale the images. The system and/or the method may have a computer programmed to automatically align the images in a post production process after the images are captured by the camera array. Alternatively, the system and/or the method may have a computer programmed to automatically align cameras with motors in the camera array, simultaneously, while filming the images.

It is, of course, generally known that stereoscopic video and/or films are created by videographing and/or filming a subject with an array of cameras. The array of cameras typically have two or more cameras, such as, for example, video cameras to capture two or more video streams of the subject. Alternatively, a single camera having optical splitters may be used to simulate multiple cameras to create stereoscopic video. For the array of cameras, the cameras are fixed to a tripod and/or a mounting bar to hold the cameras in place relative to each other while filming the subject. The tripod and/or the mounting bar are stabilized to prevent camera movement and to maintain an alignment of the cameras with respect to each other and the subject. Further, precautions are taken to physically align the cameras after the cameras are fixed to the tripod and/or the mounting bar. Unfortunately, when using a perfectly stable tripod and/or mounting bar and after taking precautions to physically align the cameras, video streams captured by the array of cameras typically are not aligned. Moreover, video streams captured by a single camera having optical splitters are generally not aligned.

For example, the video streams created by the array of cameras and/or by the single camera having optical splitters may be misaligned horizontally, vertically and/or rotationally. Still further, optics of the array of cameras may create misalignment. If zoom lenses are used with the array of cameras, a zoom setting on one of the cameras in the array may not be equivalent to a zoom setting on another camera in the array. Moreover, the cameras in the array are not manufactured to a tolerance level to allow alignment of the video streams even when identical camera models and/or zoom settings are used. As a result, the video streams of the subject typically require alignment in post production.

Known methods to align the video streams require a process of manually adjusting each of the video streams on a computer with post production non-linear editing software. Manually adjusting each of the video streams with post production non-linear editing software is time consuming, repetitive and difficult.

A need, therefore, exists for a system and/or a method for automated stereoscopic alignment of images. Further, a need exists for a system and/or a method for automated stereoscopic alignment of images, such as, for example, two or more video streams captured by a camera array having two or more video cameras. Still further, a need exists for a target having two or more identifiable points to scale and/or evaluate the video streams. The target may be placed in front of the camera array and may be filmed simultaneously by each of the cameras at a beginning of each of the video streams. Still further, a need exists for a system and/or a method that may have a computer programmed to automatically and stereoscopically align the video streams using the identifiable points on the target displayed at the beginning of each of the video streams. Still further, a need exists for a system and/or a method that may reduce post production time, effort and/or expertise required to stereoscopically align the video streams. Moreover, a need exists for a system and/or a method that may increase an accuracy and/or a precision of the alignment of the video streams.

### SUMMARY OF THE INVENTION

The present invention generally relates to a system and/or a method for automated stereoscopic alignment of images. More specifically, the present invention generally relates to a system and/or a method for automated stereoscopic alignment of images, such as, for example, two or more video streams. Each of the video streams may have one or more frames that may collectively form a motion picture. The video streams may collectively be combined to form a stereoscopic motion picture. The system and/or the method may have a camera array and/or a target to capture, to scale and/or to evaluate the images. The camera array may be two or more cameras affixed to a mounting bar and/or a tripod to maintain an orientation of the two or more cameras with respect to each other and/or with respect to a subject being filmed. The camera array may be a single camera that has optical splitters to simulate multiple cameras and to create two or more video streams. The system and/or the method may have a computer programmed to automatically and/or stereoscopically align the video streams in post production.

The target may have two or more identifiable points that may each be represented by, for example, indicia. The target may be placed in front of the camera array at a fixed distance from the camera array. The identifiable points and/or the target may be captured by the camera array at a beginning of the video streams. The computer may be programmed to capture the video streams. Further, the computer may be programmed to locate two or more of the identifiable points on the target in each of the video streams. The computer may be programmed to compare angles and/or distances between the identifiable points in each of the video streams. After comparing angles and/or distances between the identifiable points in each of the video streams, the computer may be programmed to ascertain and/or to calculate attributes of each of the video streams, such as, for example, scale, rotation, horizontal translation and/or vertical translation. The computer may be programmed to compute an offset between each of the attributes of each of the streams. The computer may be programmed to average the offset depending on a number of the cameras in the array. Still further, the computer may be programmed to compute a geometric transformation matrix for each of the video streams based on the divided offset. Moreover, the computer may be programmed to apply the geometric transformation matrix to every frame of its corresponding video stream.

To this end, in an embodiment of the present invention, a system for automated stereoscopic alignment of images is provided. The system has a camera array to capture a plurality of video streams of a subject wherein each of the plurality of video streams has a plurality of frames of the subject. Further, the system has a target having a perimeter, a front side and a back side wherein the back side is positioned opposite to the front side wherein the front side of the target has a plurality of indicia wherein the target is generally situated between the camera array and the subject wherein the front side of the target is generally exposed to the camera array wherein at least one of the plurality of frames of each of the plurality of video streams has a visual reproduction of the front side of the target. Moreover, the system has a computer in communication with the camera array wherein the computer is programmed to identify the plurality of indicia of the front side of the target, to determine a geometric orientation of each of the plurality of video streams using the plurality of indicia, and to align the video streams based upon the geometric orientation of each of the plurality of video streams.

In an embodiment, each of the plurality of indicia has a perimeter that is surrounded by the perimeter of the target.

In an embodiment, each one of the plurality of indicia is distinguishable from another one of the plurality of indicia.

In an embodiment, the geometric orientation of each of the plurality of video streams is a horizontal translation of the plurality of frames wherein the horizontal translation is indicative of a horizontal position of the plurality of frames with respect to a reference point.

In an embodiment, the geometric orientation of each of the plurality of video streams is a vertical translation of the plurality of frames wherein the vertical translation is indicative of a vertical position of the plurality of frames with respect to a reference point.

In an embodiment, the geometric orientation of each of the plurality of video streams is a rotation of the plurality of frames wherein the rotation is indicative of a rotational position of the plurality of frames with respect to a reference point.

In an embodiment, the system has a storage device to communicate the plurality of video streams to the computer.

In another embodiment, a method for automated stereoscopic alignment of images is provided. The method has the step of providing a camera array, a target and a computer wherein the camera array captures a plurality of video streams of a subject wherein the target has a first side having a plurality of indicia wherein the computer is in communication with the camera array wherein the computer stores the plurality of video streams captured by the camera array. Further, the method has the step of placing the target in a position between the camera array and the subject. Still further, the method has the step of filming the subject with the target in the position. Still further, the method has the step of removing the target from the position. Still further, the method has the step of filming the subject. Still further, the method has the step of computing a geographic orientation of each of the plurality of video streams using the computer and the plurality of indicia. Moreover, the method has the step of stereoscopically aligning the plurality of video streams with the computer.

In an embodiment, the method has the step of selecting an accuracy for stereoscopically aligning the plurality of video streams using the plurality of indicia.

In an embodiment, the method has the step of calculating an offset between the geographic orientation of each of the plurality of video streams wherein the offset is a difference between the geographic orientation of one of the plurality of video streams and another one of the plurality of video streams.

In an embodiment, the method has the step of calculating an average offset between the geographic orientation of each of the plurality of video streams wherein the average offset is half of a difference between the geographic orientation of one of the video streams and another one of the plurality of video streams.

In an embodiment, the method has the step of computing a geometric transformation matrix to apply to each of the plurality of video streams.

In an embodiment, the method has the step of outputting the stereoscopically aligned video streams.

In an embodiment, the method has the step of determining if the plurality of video streams are suitable for stereoscopic alignment using the target.

In another embodiment, a method for automated stereoscopic alignment of images is provided. The method has the step of providing a camera array, a target and a computer wherein the camera array has a plurality of cameras wherein the camera array captures a plurality of live video streams of a subject wherein each of the plurality of cameras has motorized controls to control an alignment of each of the plurality of cameras wherein the target has a first side having a plurality of indicia wherein the computer is in communication with the camera array wherein the computer is programmed to control the alignment of each of the plurality of cameras using each of the motorized controls. Further, the method has the step of placing the target in a position generally parallel to the camera array between the camera array and the subject. Still further, the method has the step of filming the subject with the target in the position. Still further, the method has the step of analyzing each of the plurality of live video streams using the plurality of indicia. Further, the method has the step of aligning each of the plurality of live video streams using the motorized controls to control the alignment of each of the plurality of cameras. Still further, the method has the step of removing the target from the position. Moreover, the method has the step of filming the subject.

In an embodiment, the method has the step of selecting an accuracy for stereoscopically aligning the plurality of live video streams.

In an embodiment, the method has the step of determining if the plurality of live video streams are suitable for stereoscopic alignment using the target.

In an embodiment, the method has the step of computing a geometric offset between each of the plurality of live video streams.

In an embodiment, the method has the step of calculating an angle and a distance between each of the plurality of indicia in each of the plurality of live video streams.

In an embodiment, the method has the step of averaging a geometric offset between each of the plurality of live video streams.

It is, therefore, an advantage of the present invention to provide a system and/or a method for automated stereoscopic alignment of images.

A further advantage of the present invention is to provide a system and/or a method for automated stereoscopic alignment of images, such as, for example, two or more video streams captured by a camera array having two or more video cameras.

Another advantage of the present invention is to provide a system and/or a method for automated stereoscopic alignment of images that has a target having two or more identifiable points to scale the video streams.

And, another advantage of the present invention is to provide a system and/or a method for automated stereoscopic alignment of images wherein the target may be placed in front of the camera array and may be filmed simultaneously by each of the cameras at a beginning of each of the video streams.

Yet another advantage of the present invention is to provide a system and/or a method for automated stereoscopic alignment of images that may have a computer programmed to automatically and/or stereoscopically align the video streams using the identifiable points on the target displayed at the beginning of each of the video streams.

A further advantage of the present invention is to provide a system and/or a method for automated stereoscopic alignment of images that may reduce post production time, effort and/or expertise required to stereoscopically align the video streams.

A still further advantage of the present invention is to provide a system and/or a method for automated stereoscopic alignment of images that may increase an accuracy and/or a precision of the alignment of the video streams.

Moreover, an advantage of the present invention is to provide a system and/or a method for automated stereoscopic alignment of images that may have indicia on the target representing one or more of the identifiable points.

And, another advantage of the present invention is to provide a system and/or a method for automated stereoscopic alignment of images that may place the target in front of the camera array at a fixed distance from the camera array wherein the camera array may capture the identifiable points and/or the target at a beginning of the video streams.

Yet another advantage of the present invention is to provide a system and/or a method for automated stereoscopic alignment of images that may have a computer programmed to capture the video streams.

Another advantage of the present invention is to provide a system and/or a method for automated stereoscopic alignment of images that may locate two or more of the identifiable points on the target in each of the video streams.

And, another advantage of the present invention is to provide a system and/or a method for automated stereoscopic alignment of images that may compare angles and/or distances between the identifiable points in each of the video streams.

Yet another advantage of the present invention is to provide a system and/or a method for automated stereoscopic alignment of images that may ascertain and/or calculate attributes of each of the video streams, such as, for example, scale, rotation, horizontal translation and/or vertical translation.

A further advantage of the present invention is to provide a system and/or a method for automated stereoscopic alignment of images that may compute an offset between each of the attributes of each of the streams.

A still further advantage of the present invention is to provide a system and/or a method for automated stereoscopic alignment of images that may average the offset depending on a number of the cameras in the array.

Another advantage of the present invention is to provide a system and/or a method for automated stereoscopic alignment of images that may compute a geometric transformation matrix for each of the streams based on the divided offset.

And, another advantage of the present invention is to provide a system and/or a method for automated stereoscopic alignment of images that may apply each geometric transformation matrix to every frame of its corresponding video stream to align the video stream.

Yet another advantage of the present invention is to provide a system and/or a method for automated stereoscopic alignment of images that may align all video streams in a stereoscopic motion picture based on an average offset.

A further advantage of the present invention is to provide a system and/or a method for automated stereoscopic alignment of images that may homogeneously apply alignment transformations to the images.

Moreover, an advantage of the present invention is to provide a system and/or a method for automated stereoscopic alignment of images that may provide real-time feed back to motors that may control camera positions during filming which may eliminate a need to align the video streams during post production.

Additional features and advantages of the present invention are described in, and will be apparent from, the detailed description of the presently preferred embodiments and from the drawings.

### BRIEF DESCRIPTION OF THE DRAWINGS

FIG. 1A illustrates a top view of a system for automated stereoscopic alignment of images in an embodiment of the present invention.

FIG. 1B illustrates a side view of a system for automated stereoscopic alignment of images in an embodiment of the present invention.

FIG. 1C illustrates a black box diagram of a system for automated stereoscopic alignment of images in an embodiment of the present invention.

FIG. 2 illustrates a target for automated stereoscopic alignment of images in an embodiment of the present invention.

FIG. 3 illustrates a flowchart a method for automated stereoscopic alignment of images in an embodiment of the present invention.

FIG. 4 illustrates a flowchart of a method for automated stereoscopic alignment of images in an embodiment of the present invention.

FIG. 5 illustrates a flowchart of a method for automated stereoscopic alignment of images in an embodiment of the present invention.

### DETAILED DESCRIPTION OF THE PRESENTLY PREFERRED EMBODIMENTS

The present invention generally relates to a system and/or a method for automated stereoscopic alignment of images. More specifically, the present invention generally relates to a system and/or a method for automated stereoscopic alignment of images, such as, for example, two or more video streams. The system and/or the method may have a camera array and/or a target to capture and/or to scale the images. The system and/or the method may have a computer programmed to automatically align the video streams before, during and/or after filming of a subject.

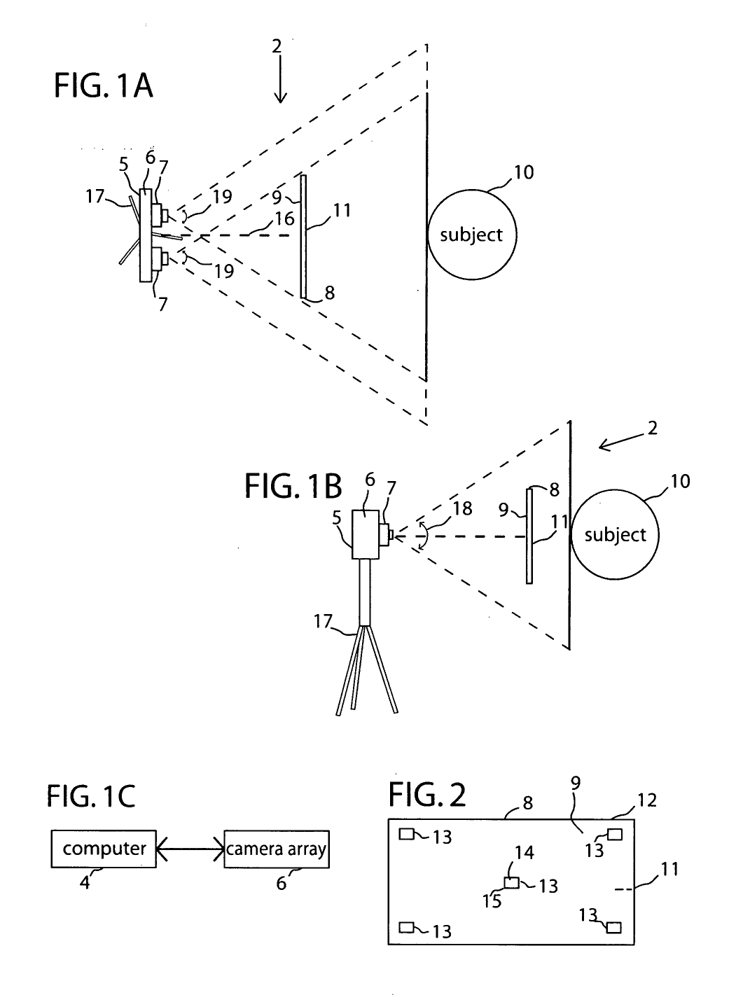

Referring now to the drawings wherein like numerals refer to like parts, FIGS. 1A, 1B and 1C generally illustrate a system 2 having a computer 4 and a camera array 6 that may be connected thereto and/or that may be in communication therewith. Further, the system 2 may have a target 8 and/or a subject 10 to be filmed by the camera array 6. In an embodiment, the target 8 may be situated between the subject 10 and the camera array 6. The subject 10 may be, for example, any person, object, scene, light and/or collection of the same that may be captured as images by the camera array 6.

The computer 4 may be any type of computer that may import, store, manipulate, analyze and/or communicate images captured by the camera array 6. In an embodiment, the computer 4 may be an integrated portion of the camera array 6. In embodiment, the computer 4 may not be connected to or in direct communication with the camera array 6; however, the computer 4 may be capable of importing, storing, manipulating, analyzing, editing, transforming, aligning, compositing and/or communicating images captured by the camera array 6 and/or communicated to the computer 4 via a storage medium, such as, for example, a hard drive, a cd, a dvd, a flash memory drive, a video tape, a cassette tape, a portable electronic device, a wireless medium and/or the like. The computer 4 may be programmed to and/or may have software to import, store, manipulate, analyze, edit, transform, align, composite and/or communicate the images. Of course, the computer 4 may be any number of computers that may be required to import, store, manipulate, analyze and/or communicate images captured by the camera array 6. The computer 4 may be, for example, a desktop computer, a laptop computer, a server and/or the like. The present invention should not be deemed as limited to a specific embodiment of the computer 4. It should be understood that the computer 4 may be any computer known to one having ordinary skill in the art.

The camera array 6 may be two or more cameras 7 that may be affixed to a mounting bar 5, a panel and/or a tripod 17 to maintain an orientation of the cameras 7 with respect to each other and/or with respect to a subject 10 being filmed. Alternatively, the camera array may be a single camera that may have optical splitters to simulate multiple cameras and to create two or more video streams. The camera array 6 may have mounts to attach the cameras 7 to the bar 5, the panel and/or the tripod. The cameras 7 of the camera array 6 may have a layout, such as, for example a planar layout, a planar and slanted layout, a spherical layout, and/or the like. Further, the mounts may allow for aiming and/or adjustment of the cameras 7. In an embodiment, the mounts may have motorized controls to adjust, for example, a roll, a pitch and/or a yaw of one or more of the cameras 7. In an embodiment, the motorized controls may be controlled by the computer 4.

In an embodiment, the camera array 6 may be two or more panels of cameras 7 having a variety of orientations with respect to the subject 10. The cameras 7 of the camera array 6 may be, for example, analog video cameras, analog movie cameras, digital video cameras, digital movie cameras, digital photo cameras, photographic film cameras, medium film cameras, motion picture film cameras and/or the like. Further, the cameras 7 may have accessories attached thereto, such as, for example, batteries, power supplies, film stock cases, data cables, zoom lenses, filters, memory and/or the like. The cameras 7 may be in communication with the computer 4 and/or other like storage devices for storing the images and/or for transferring the images to a useful medium. The present invention should not be deemed as limited to a specific embodiment of the camera array 6 and/or the cameras 7. It should be understood that the camera array 6 and/or the cameras 7 may be any camera array and/or cameras to capture images as known to one having ordinary skill in the art.

In an embodiment, each of the cameras 7 may simultaneously capture two or more images of the subject 10 which, collectively, may be, for example, a video stream. Each video stream captured by each of the cameras 7 may be a motion picture of the subject 10. The video streams may be combined to form a stereoscopic motion picture. The video streams may be, for example, analog and/or digital. In an embodiment, the video streams may be uncompressed and/or compressed digital data files that may be imported, stored, manipulated, analyzed, reviewed, displayed, projected and/or communicated by the computer 4. The present invention should not be deemed as limited to a specific embodiment of the images and/or the video streams. It should be understood that the images and/or the video streams may be any still and/or motion pictures as known to one having ordinary skill in the art.

As shown in FIGS. 1A and 1B, a target 8 may be situated between the cameras 7 of the camera array 6 and the subject 10 and/or a portion of the subject 10. The target 8 may be, for example, a board, a sign and/or other like object having a front surface 9 that may be exposed to the cameras 7 of the camera array 6. In an embodiment, as shown in FIGS. 1A, 1B and 2, the front surface 9 may be generally planar. In an embodiment, the target 8 may have a width defined between the front surface 9 and a back surface 11 that may be positioned generally opposite to the front surface 9. Further, the front surface 9 may be defined by a perimeter 12 of the target 8. In an embodiment, as shown in FIG. 2, the target 8 may be generally rectangular in shape. However, the target 8 may have any shape and/or geometry as know to a person of ordinary skill in the art.

In an embodiment, the front surface 9 of the target 8 may have two or more identifiable points 13 that may each be represented by, for example, indicia that may be printed and/or affixed to the front surface 9. In an embodiment, the identifiable points 13 may be, for example, rectangular indicia 14 each having a perimeter 15 that may be surrounded by the perimeter 12 of the front surface 9 of the target 8. The identifiable points 13 may be any color and/or shape that may be distinguishable from the front surface 9 of the target 8. Further, the identifiable points 13 may be located at varying positions on the front surface 9 of the target 8. The present invention should not be deemed as limited to a specific embodiment of the target 8 and/or the identifiable points 13. It should be understood that the target 8 and/or the identifiable points 13 may be any generally planar object having indicia as known to one having ordinary skill in the art.

As generally shown in FIGS. 1A and 1B, the target 8 may be situated between the camera array 6 and the subject 10. In an embodiment, the front surface 9 of the target 8 and, therefore, the identifiable points 13 may be exposed to the cameras 7 of the camera array 6. In an embodiment, the front surface 9 may be positioned generally parallel to the mounting bar 5 of the camera array 6. The target 8 may be situated a distance 16 from the camera array 6. The distance 16 may be, for example, any distance at which an entirety of the perimeter 12 of the target 8 and/or at least two of the identifiable points 13 may be situated in a field of view 18, 19 of each of the cameras 7. Images of the target 8 that may be captured by the cameras 7 of the camera array 6 may include the target 8 and/or the identifiable points 13.

Positions and size of the target 8 and/or the identifiable points 13 in the images may be captured by the cameras 7 and may be indicative of an alignment of each camera 7, the images and/or the video streams captured by the camera 7. The positions and/or the size of the target 8 and/or the identifiable points 13 in the image may be indicative of, for example, a perspective of the image, a scale of the image, a vertical translation of the image, a horizontal translation of the image, and/or a rotation of the image.

The computer 4 may be programmed to analyze the images and/or the video streams captured by the cameras 7. A portion of each of the video streams may include the target 8 and/or the identifiable points 13. The computer 4 may be programmed to locate and/or identify two or more of the identifiable points 13 on the target 8 in each of the video streams. Further, the computer 4 may be programmed to identify a size, a rotation and/or an orientation of the target 8 and the identifiable points 13. The computer 4 may be programmed to compare angles and/or distances between the identifiable points in each of the video streams.

After comparing angles and/or distances between the identifiable points 13 in each of the video streams, the computer 4 may ascertain and/or calculate attributes of each of the video streams, such as, for example, the perspective of the image, the scale of the image, the vertical translation of the image, the horizontal translation of the image, and/or the rotation of the image. The computer 4 may compute an offset between each of the attributes of each of the video streams. The computer 4 may average the offset based on a number and/or a position of the cameras in the camera array 6. Still further, the computer 4 may compute a geometric transformation matrix for each of the video streams based on the averaged offset. Moreover, the computer 4 may apply each geometric transformation matrix to every frame of each video stream.

For example, in a camera array 6 having two cameras 7, the computer 4 may calculate the offset of the rotation of the images to total, for example, one (1) degree. To align the rotation, the computer 4 may average the offset between the two cameras equaling one-half (½) degree per video stream. The computer 4 may compute and/or apply the geometric transformation matrix to every frame of each video stream effectively rotating each stream one-half (½) degree in opposing directions. As a result, the video streams may be rotationally aligned, which may be apparent when the streams are combined for stereoscopic viewing. In an embodiment, the computer 4 may calculate the offset and the average offset for any of the attributes desired by a user of the system 10. Further, the computer 4 may automatically apply the geometric transformation matrix to each of the video streams captured by the camera array 6. The offset of each of the attributes and the average offset to be applied to each of the attributes of each of the video streams may be calculated for any camera array 6 having two or more of the video streams. The present invention should not be deemed as limited to a maximum number of streams to be automatically aligned. It should be understood that the number of streams to be compared and/or aligned may be any number of streams that may form a stereoscopic image as known to one having ordinary skill in the art.

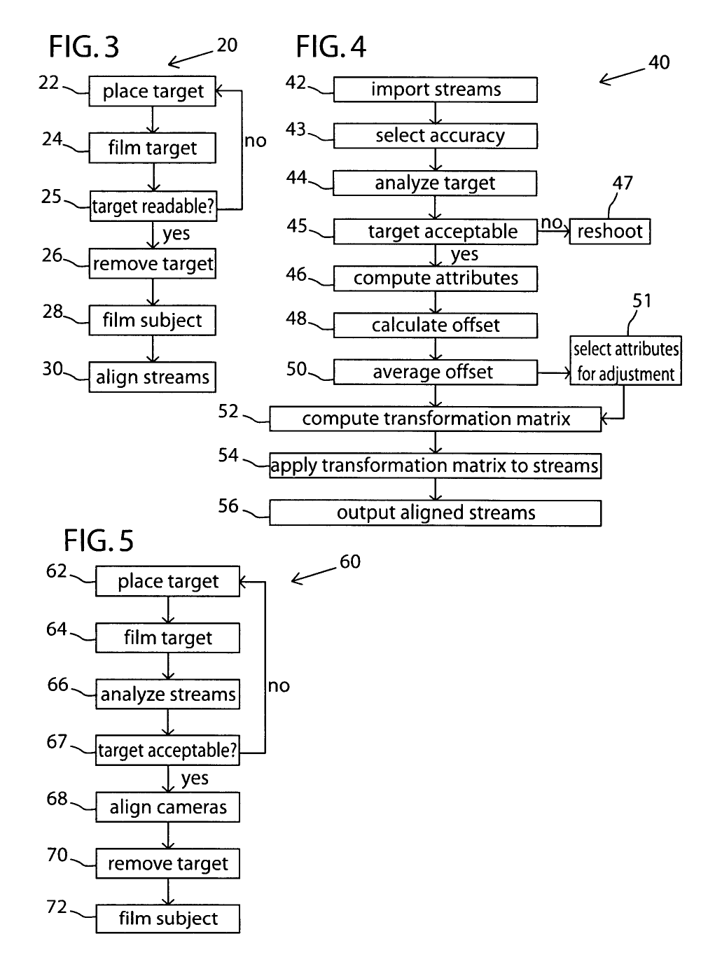

Referring now to FIG. 3, a method 20 for automated stereoscopic alignment of images having a sequence of steps is generally shown. Particularly, the method 20 may place the target 8, shown at step 22. In an embodiment, the target 8 may be placed between the camera array 6 and the subject 10 as shown in FIG. 1 and as herein described above. In an embodiment, as shown at step 24, the cameras 7 of the camera array 6 may film the subject 10 while the target 8 is situated in a foreground of a shot for a length of time. In an embodiment, the length of time may be any length of time required for each of the cameras 7 to capture at least one frame of the target 8. In an embodiment, as shown at step 25, the video streams of the target may be analyzed to determine if the target 8 is readable. If the target 8 is not readable, steps 22 and 24 may be repeated until the target 8 is readable in the video streams. The present invention should not be deemed as limited to the length of time that the target 8 is filmed.

As shown at step 26, the method 20 may remove the target 8 from the foreground and/or from a view of the cameras 7 of the camera array 6. As shown at step 28, the method 20 may proceed to film the subject 10 to capture the video streams that may later be aligned using the target 8 that may be captured at a sequence of the video feeds. In an embodiment, the sequence may occur at any frame and/or frames of the video streams. In an embodiment, the video streams may be automatically aligned using the computer 4 as herein described above and as further shown in FIG. 4 and as described below.

Referring now to FIG. 4, a method 40 for automated stereoscopic alignment of images having a sequence of steps is generally shown. Particularly, the method 40 may import the video streams into the computer 4 for evaluation, for processing and/or for alignment of streams as shown at step 42. In an embodiment, the method 40 may import the video streams via a direct communication link between the camera array 6 and the computer 4, such as, for example, a data cable and/or the like. In an embodiment, the method 40 may import the video streams into the computer 4 via a storage medium which may hold data relating to the video streams, such as, for example, a hard drive, a cassette tape, a cd, a dvd, a flash memory drive and/or the like. The present invention should not be deemed as limited to a specific means for importing the video streams into the computer 4.

In an embodiment, as shown at step 43, the method 40 may select an accuracy with which the target 8 is analyzed and/or with which the attributes of the video streams are calculated. In an embodiment, as shown at step 44, the method 40 may analyze the target 8 and/or the identifiable points 13 appearing at the beginning sequence of each of the video streams. In an embodiment, the method 40 may identify and/or locate the identifiable points and/or may calculate distances and/or angles between two or more of the identifiable points 13. In an embodiment, as shown at step 45, the method may determine if the target 8 and/or the identifiable points 13 are acceptable as they appear in the video streams and/or if enough information is available in the target 8 to compute the attributes within the accuracy selected at step 43. If the target 8 and/or the identifiable points 13 are not acceptable, as shown at step 45, the method 40 may reshoot the target 8 and/or may repeat steps 42-46. If the target 8 and/or the identifiable points 13 are acceptable, as shown at step 46, the method 40 may compute the attributes of each of the video feeds which may be, for example, the perspective of the image, the scale of the image, the vertical translation of the image, the horizontal translation of the image, and/or the rotation of the image. As shown at step 48, the method 40 may calculate the offset between each of the attributes of each of the video streams as herein described above. Further, the method 40 may calculate the average offset to be applied to each of the video streams as shown at step 50 and as herein described above. In an embodiment, as shown at step 51, the method 40 may allow a user to select the attributes of the video streams to be aligned. For example, the user may desire to not apply the average offset to, for example, the horizontal translation of the video streams. The method 40 may allow the user to avoid aligning the streams, for example, horizontally. Further, the method 40 may allow the user to manually change the average offset to be applied to the video streams. The present invention should not be deemed as limited to a specific combination of the attributes selected for alignment.

Based upon the average offset and the attributes that may be selected for alignment, the method 40 may compute the geometric transformation matrix to be applied to each of the video streams as shown at step 52. The method 40 may apply the geometric transformation matrix to every frame of the video streams which may align the video streams as shown at step 54. In an embodiment, the method 40 may output the aligned video streams in a file format selected by the user of the computer 4 as shown at step 56. The present invention should not be deemed as limited to a specific embodiment of the format of the aligned video streams. The aligned video streams may be further manipulated, composited, aligned and/or edited as needed in creation of a stereoscopic motion picture.

Referring now to FIG. 5, a method 60 for automated stereoscopic alignment of images having a sequence of steps is shown. Particularly, the method 20 may place the target 8 as shown at step 62. The target 8 may be placed between the camera array 6 and the subject 10. In an embodiment, as shown at step 64, the method 60 may film two or more live video feeds of the subject 10 while the target 8 is situated in a foreground of a shot for a length of time. In an embodiment, as shown at step 66, the method 60 may analyze the target 8 and/or the identifiable points 13 of the live video feeds in real time. In an embodiment, as shown at step 67, the method 60 may determine if the target 8 as captured in the video streams is acceptable for alignment of the streams. If the target 8 as captured is not acceptable, steps 62, 64 and/or 66 may be repeated until the target 8 is acceptable. If the target 8 as captured is acceptable, the method 60 may align the cameras 7, as shown at step 68. The method 60 may actuate motorized controls on the cameras 7 of the camera array 6 to control a roll, a pitch and/or a yaw of the cameras 7. As a result the video streams may be aligned before a filming of the subject 10. As shown at step 70, the method 60 may remove the target from the shots. As shown at step 72, the method 60 may film the subject with the pre-aligned cameras which may eliminate a need for a post production alignment of the video streams.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for automated stereoscopic alignment of images, the system comprising:
a camera array to capture a plurality of video streams of a subject wherein each of the plurality of video streams has a plurality of frames of the subject;
a target having a perimeter, a front side and a back side wherein the back side is positioned opposite to the front side wherein the front side of the target has a plurality of indicia wherein the target is generally situated between the camera array and the subject wherein the front side of the target is generally exposed to the camera array wherein at least one of the plurality of frames of each of the plurality of video streams has a visual reproduction of the front side of the target; and
a computer in communication with the camera array wherein the computer is programmed to identify the plurality of indicia of the front side of the target, to determine a geometric orientation of each of the plurality of video streams using the plurality of indicia, and to align the video streams based upon the geometric orientation of each of the plurality of video streams.

2. The system of claim 1 wherein each of the plurality of indicia has a perimeter that is surrounded by the perimeter of the target.

3. The system of claim 1 wherein each one of the plurality of indicia is distinguishable from another one of the plurality of indicia.

4. The system of claim 1 wherein the geometric orientation of each of the plurality of video streams is a horizontal translation of the plurality of frames wherein the horizontal translation is indicative of a horizontal position of the plurality of frames with respect to a reference point.

5. The system of claim 1 wherein the geometric orientation of each of the plurality of video streams is a vertical translation of the plurality of frames wherein the vertical translation is indicative of a vertical position of the plurality of frames with respect to a reference point.

6. The system of claim 1 wherein the geometric orientation of each of the plurality of video streams is a rotation of the plurality of frames wherein the rotation is indicative of a rotational position of the plurality of frames with respect to a reference point.

7. The system of claim 1 further comprising:
a storage device to communicate the plurality of video streams to the computer.

8. A method for automated stereoscopic alignment of images, the method comprising the steps of:
providing a camera array, a target and a computer wherein the camera array captures a plurality of video streams of a subject wherein the target has a first side having a plurality of indicia wherein the computer is in communication with the camera array wherein the computer stores the plurality of video streams captured by the camera array;
placing the target in a position between the camera array and the subject;
filming the subject with the target in the position;
removing the target from the position;
filming the subject;
computing a geographic orientation of each of the plurality of video streams using the computer and the plurality of indicia; and
stereoscopically aligning the plurality of video streams with the computer.

9. The method of claim 8 further comprising the step of:
selecting an accuracy for stereoscopically aligning the plurality of video streams using the plurality of indicia.

10. The method of claim 8 further comprising the step of:
calculating an offset between the geographic orientation of each of the plurality of video streams wherein the offset is a difference between the geographic orientation of one of the plurality of video streams and another one of the plurality of video streams.

11. The method of claim 8 further comprising the step of:
calculating an average offset between the geographic orientation of each of the plurality of video streams wherein the average offset is half of a difference between the geographic orientation of one of the video streams and another one of the plurality of video streams.

12. The method of claim 8 further comprising the step of:
computing a geometric transformation matrix to apply to each of the plurality of video streams.

13. The method of claim 8 further comprising the step of:
outputting the stereoscopically aligned video streams.

14. The method of claim 8 further comprising the step of:
determining if the plurality of video streams are suitable for stereoscopic alignment using the target.

15. A method for automated stereoscopic alignment of images, the method comprising the steps of providing a camera array, a target and a computer wherein the camera array has a plurality of cameras wherein the camera array captures a plurality of live video streams of a subject wherein each of the plurality of cameras has motorized controls to control an alignment of each of the plurality of cameras wherein the target has a first side having a plurality of indicia wherein the computer is in communication with the camera array wherein the computer is programmed to control the alignment of each of the plurality of cameras using each of the motorized controls;
placing the target in a position generally parallel to the camera array between the camera array and the subject;
filming the subject with the target in the position;
analyzing each of the plurality of live video streams using the plurality of indicia;
aligning each of the plurality of live video streams using the motorized controls to control the alignment of each of the plurality of cameras;
removing the target from the position; and
filming the subject.

16. The method of claim 15 further comprising the step of:
selecting an accuracy for stereoscopically aligning the plurality of live video streams.

17. The method of claim 15 further comprising the step of:
determining if the plurality of live video streams are suitable for stereoscopic alignment using the target.

18. The method of claim 15 further comprising the step of:
computing a geometric offset between each of the plurality of live video streams.

19. The method of claim 15 further comprising the step of:
calculating an angle and a distance between each of the plurality of indicia in each of the plurality of live video streams.

20. The method of claim 15 further comprising the step of:
averaging a geometric offset between each of the plurality of live video streams.
